(19) United States
(12) Patent Application Publication
(10) Pub. No.: US 2007/0052389 A1
(43) Pub. Date: Mar. 8, 2007

(54) Battery receptacle

(76) Inventor: Michiel Kooij, Camperdown (AU)

Correspondence Address: McCARTER & English, LLP;Financial Centre, Suite 304A, 695 East Main Street, Stamford, CT, 06901-2183, US

(21) Appl. No.: 11/488,477

(22) Filed: Jul. 18, 2006

(30) Foreign Application Priority Data
Jul. 19, 2005 (AU) 2005903825

(51) Int. Cl. H02J 7/00

(52) U.S. Cl. 320/114

(57) ABSTRACT

A battery receptacle for use with a medical device, said receptacle comprising at least one cavity accessed via a respective door, said cavity adapted to slidably receive at least one non-cylindrical battery to engage with electrical contacts in a single predetermined orientation, said receptacle and said battery each being provided with complementary slidable engagement means that must be engaged with each other when inserting said battery into said cavity, thereby only allowing said battery to engage said contacts in said single predetermined configuration, and wherein said receptacle further comprising at least one portion that allows said battery to be visible when said battery is inserted in said cavity and said door is closed.

### FIELD OF THE INVENTION

The present invention relates to improvements in battery receptacles for use with battery-powered devices, and in particular with battery-powered medical devices including implantable blood pumps and left ventricle assist devices.

### BACKGROUND OF THE INVENTION

Implantable blood pumps may typically rely on power sources external to the patients to provide power to drive the blood pumps. One known power source has been by batteries housed within battery receptacles.

The known battery receptacles typically comprise a housing adapted to house a primary battery and a reserve battery within a housing. These two batteries function to sequentially supply power to battery-powered devices such as implantable blood pumps, and are typically charged by connection to wall sockets or chargers. Implantable blood pumps have very specific power requirements and these requirements include the need for a continuous power source. If the blood pump is stopped, even for a short time, the stoppage may lead to the formation of blood clots within the circulatory system of the patient or the blood pump. Therefore, many battery-powered medical devices need a reliable, continuous and portable power supply.

Patients implanted with implantable blood pumps are primarily responsible for maintenance and charging of batteries that power their own medical devices. One disadvantage associated with this fact, is that patients often forget proper handling procedures for batteries. This failure of incorrect battery handling procedures may lead to the batteries being incorrectly inserted or jammed with the battery receptacle. This may in turn lead to the patient injuring themselves.

Also, patients may accidentally remove both batteries simultaneously from the battery receptacle, which may also result in medical device stoppage and in the case of implantable blood pumps may lead to life threatening conditions including thrombogenesis.

The present invention aims to at least address or ameliorate one or more of the above problems associated with the prior art disclosures.

### SUMMARY OF THE INVENTION

According to a first aspect the present invention consists of a battery receptacle for use with a medical device, said receptacle comprising at least one cavity accessed via a respective door, said cavity adapted to slidably receive at least one non-cylindrical battery to engage with electrical contacts in a single predetermined orientation, said receptacle and said battery each being provided with complementary slidable engagement means that must be engaged with each other when inserting said battery into said cavity, thereby only allowing said battery to engage said contacts in said single predetermined configuration, and wherein said receptacle further comprising at least one portion that allows said battery to be visible when said battery is inserted in said cavity and said door is closed.

Preferably said complementary engagement means comprises an elongate ridge and a groove, one of which is disposed on the battery and the other disposed within said cavity.

Preferably said at least one non-cylindrical battery is two batteries and said at least one cavity is two cavities each of which has a respective door, one of said two batteries is a primary battery and other is a reserve battery, and said two batteries in combination are adapted to provide an uninterrupted power supply to said medical device.

Preferably said least one portion that allows said battery to be visible is disposed on said door.

Preferably said door is made of a clear or translucent plastic.

Preferably said door is made of polycarbonate.

Preferably said two doors are distinguished from each other by different colors and/or indicia marked thereon.

Preferably said door is lockable by use of a latch means.

Preferably said receptacle is for use with an implantable blood pump.

### BRIEF DESCRIPTION OF THE DRAWINGS

Embodiments of the present invention will now be described with reference to the accompanying drawings wherein:

FIG. 1 shows a cross-sectional view of a first embodiment of the present invention exposing the interior of the device;

FIG. 2 shows a perspective view of a first embodiment of the present invention; and

FIG. 3 shows a perspective view of a preferred battery to be used with the first embodiment shown in FIGS. 1 and 2.

### BRIEF DESCRIPTION OF THE PREFERRED EMBODIMENTS

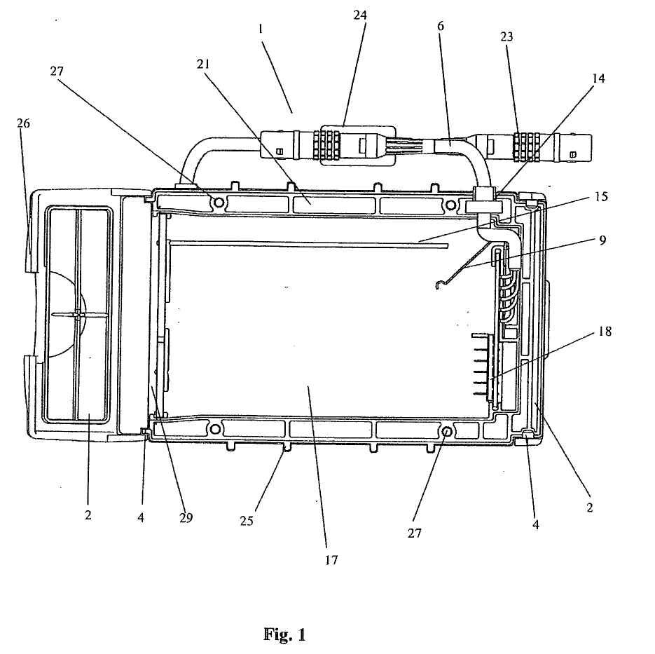

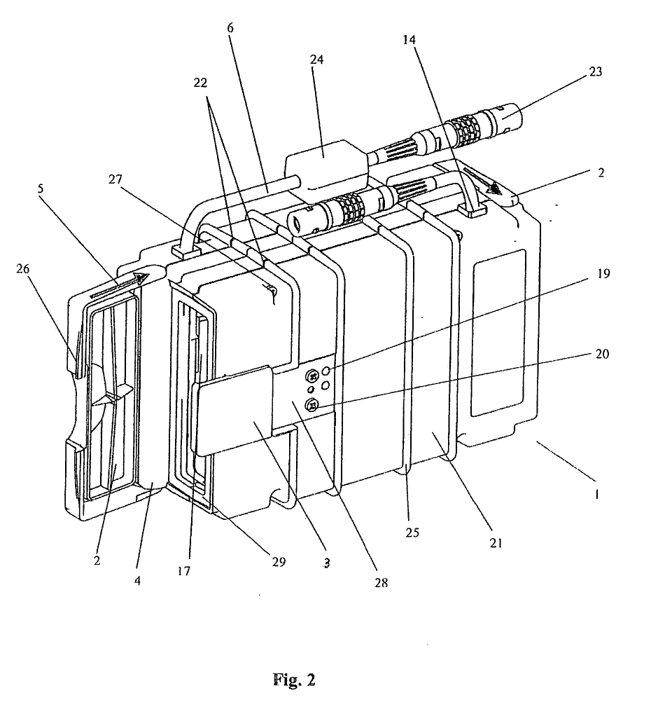

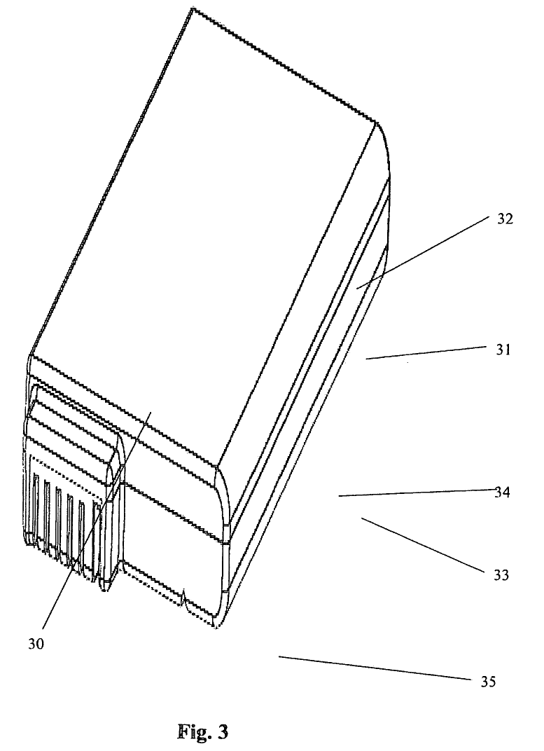

In a first preferred embodiment of the present invention, depicted in FIGS. 1 and 2, there is provided a battery receptacle 1 for receiving a number of batteries. In this first embodiment, the battery receptacle 1 is adapted to receive two batteries being primary and reserve batteries 30, as shown in FIG. 3.

When in use, the primary and reserve batteries 30 may be used in conjunction with the first embodiment and may be received within respective slots 17 or cavities in the battery receptacle 1. The batteries 30 connect with electrical contacts 18 preferably mounted at the end of the slot 17 in a manner so as to allow the batteries to be easily inserted and removed, when desired. Spring mechanism 9 is mounted in the end of the slot 17 and this spring mechanism 9 may provide sufficient force against the respective batteries so as to allow it to be automatically ejected when either the primary or reserve battery 30 is not secured.

In this embodiment, the batteries 30 are adapted to be slidably engaged within the cavity 17 and thereby only allowing said battery 30 to engage said contacts 18 in a single predetermined configuration and orientation.

Batteries 30, when inserted in slot 17, are secured by a door 2 which covers the rear end of the battery. The door 2 is hinged at hinges 4 and are allowed to open and close by the operation of the user or patient. The door 2 may be latched in place by a latch 3 which is capable of being deflected by the user or patient out of the path of the door 2 and thereby allow the door 2 to be swung open by the user or patient. The latch 3 is preferably spring biased using a metal strip 28 joined to outer surface of the body 21 of the battery receptacle 1 by two screws 20 and three notches 19. The positioning notches 19 and the screws 20, in the shown configuration, may strengthen and improve the function of the latch 3.

The battery receptacle 1 may include a positioning strip 15 which is mounted on one of the interior cavities of the battery receptacle 1, which forms the slot 17. This positioning strip 15 is adapted to be received by a corresponding positioning groove (not shown) that runs lengthwise along the outer surface of the batteries 30. The combination of the positioning strip 15 and the positioning groove ensures that each battery 30 may only be inserted into the receptacle 1 in a single orientation. This substantially minimises the risk of a patient or other user misaligning or jamming a battery 30 into receptacle 1.

The battery receptacle 1 also may include one or more clear or translucent regions. These clear or translucent regions allow the user or patient to visually assess whether one or more of the batteries are within the battery receptacle 1 without having to open the doors 2 for internal inspection. Preferably, the doors 2 are constructed in such a manner as to form said clear or translucent regions. When in use, the patient can simply look at either end of the battery receptacle 1 and assess whether a battery is in the slot 17. This safety feature prevents accidental removal of batteries from battery receptacle 1.

Additionally in the first preferred embodiment, the transparent doors 2 may be coloured differently. Preferably, the door 2 covering the primary battery is coloured orange and the alternate door 2 is clear. This differential colour pattern of the doors 2 makes it easier for a patient to distinguish the slot 17 for the primary battery and the slot 17 for the reserve battery. This further prevents accidental mishaps from occurring with the patient using the attached medical device. Of course it should be understood that the doors 2 may be marked with indicia in order for the patient or user to distinguish the slots for the primary and reserve batteries.

Preferably, the doors 2 of the first embodiment are constructed of a transparent polymer. The preferred transparent polymer is polycarbonate (‘PC’) which is preferably transparent. Additionally, the doors may be dyed with various colours and still retain a relatively translucent or transparent nature.

The body 21 of the battery receptacle 1 is preferably constructed of Acrylonitrile Butadiene Styrene (‘ABS’). However other resilient materials may be also used. Preferably, the body 21 and/or doors 2 may be constructed of material that is relatively fire resistant or flame retardant.

Preferably, the doors 2 may be mounted on opposite ends of the body 21 and face opposing directions (as shown in FIGS. 1 and 2). Preferably, the door 2 for receiving the primary battery may be forward facing (as per FIG. 2). This may be useful in situations where battery receptacle 1 is being carried by a patient or user so as to allow improved accessibility by the patient or user to the slot 17 which most commonly receives a battery (i.e. the primary battery). The rear facing door 2 may be used for the reserve battery which generally requires less replacement and thus also less access by the patient or user. This preferred configuration of the doors 2 may improve the overall useability of the battery receptacle 1 by the patient or user.

In this embodiment, the body 21 of battery receptacle 1 is formed of both screwing three portions together to form the body 21. The battery receptacle 1 includes two joins 22 running longitudinally along the body 21 and each join 22 may be secured together with 4 screws 27. It may also be desirable to seal these joins 22 to allow the body 21 to be water proof or at least partially water resistant. In this embodiment, a seal 13 has been included and is inserted within both joins 22 and extends into the recess 29 in the body 21 that receives the doors 2.

This embodiment also includes partially reflective or fluorescent regions on the batteries 10 and 11 to improve visibility when viewed through the transparent regions. These regions may be achieved by placing a reflective sticker 12 on an end of the battery 10 and 11 that is visible through the transparent or translucent region of battery receptacle 1. Additionally, an internal light or LED (not shown) may be included within the slot 17 of the battery receptacle 1. This internal light may also further increase the visibility of the batteries 10 and 11, when they are inside the slot 17 of the battery receptacle 1.

The battery receptacle 1 may also include two cables 6 joined to the electrical sockets 18 through the body 21. Preferably, where the cables 6 extend into the body 21 and are sealed with grommets 14 to increase the wear resistance and the water resistance. The external ends of the cables 6 may be each attached to a wear resistant Lemo™ plug 23. Preferably, the Lemo™ plugs 23 may be coloured coded to match the door 2 colour for ease of use.

The cables 6 in the first preferred embodiment include five (5) wires (not shown) which connect the batteries via connection to electrical sockets 18. The Lemo™ plugs 23 also include five (5) pins (not shown) and these pins are connected to the respective five (5) wires within the cables 6. Preferably, attached to the outer surface of the cables 6 are magnetic shields 24. These magnetic shields 24 reduce EMF interference experienced by electrical signals travelling within the cables 6, when in use.

Preferably, the doors 2 may also be marked with an ‘arrow’ label 5. This label 5 denotes the direction with which the preferred battery is to be inserted within the slot 17. When the doors 2 are in an open position, the ‘arrow’ label 5 may match a similar ‘arrow’ label positioned on the preferred batteries. This allows the patient or user to easily orientate the battery with ‘arrow’ label 5 to allow correct insertion into the appropriate slot 17.

The doors 2 and/or the body 21 of the battery receptacle 1 may include ribbing or reinforcing to improve the overall wear resistance and durability of the battery receptacle 1. This ribbing or reinforcing may be seen in the first preferred embodiment as a series of ribs 25 extending vertically around the outer surface of the body 21 of the battery receptacle 1. The doors 2 may each include a finger grip 26 extending from the outer surface of the doors 2. The finger grip 26 may assist the patient or user to open the doors 2.

In this first embodiment, a preferred battery 30, is shown in FIG. 3. This battery 30 is a non cylindrical battery of 12 volt NiMH type. The battery 30 includes: a positioning groove 31, which is adapted to engage the positioning strip 15; a socket 34 for engaging with the battery receptacle 1 and wherein said socket 34 includes six (6) electrical contacts 33 for connecting with contacts 18. The upper surface 32 of the battery 30 maybe rounded and the bottom surface 35 may have generally square shaped profile. Preferably, the battery receptacle 1 is attached to receive battery 30 within cavity 17 in a single orientation and the surface profiles of the upper and lower surfaces 32 and 35 may further enhance this feature. The battery 30 may also include a flexible pull tab (not shown) on the opposed 20 end relative to socket 34 to allow for easier removal from the battery receptacle 1 and/or may also include an LED power gauge on the outer surface of the batteries to allow the patient or user to easily detect the remaining charge in each respective battery.

The battery receptacle 1 is preferable designed or adapted for use with medical devices to provide a power source. These medical devices may include implantable blood pumps, or left ventricle assist devices. Specifically, the battery receptacle 1 may be used in conjunction with the blood pump described in U.S. Pat. No. 6,227,797—Watterson et al.

The above descriptions detail only some of the embodiments of the present invention. Modifications may be obvious to those skilled in the art and may be made without departing from the scope and spirit of the present invention.

The term “comprising” (and its grammatical variations) as used herein is used in the inclusive sense of “having” or “including” and not in the exclusive sense of “consisting only of”.

1. A battery receptacle for use with a medical device, said receptacle comprising at least one cavity accessed via a respective door, said cavity adapted to slidably receive at least one non-cylindrical battery to engage with electrical contacts in a single predetermined orientation, said receptacle and said battery each being provided with complementary slidable engagement means that must be engaged with each other when inserting said battery into said cavity, thereby only allowing said battery to engage said contacts in said single predetermined configuration, and wherein said receptacle further comprising at least one portion that allows said battery to be visible when said battery is inserted in said cavity and said door is closed.

2. A battery receptacle for use with a medical device as claimed in claim 1, wherein said complementary engagement means comprises an elongate ridge and a groove, one of which is disposed on the battery and the other disposed within said cavity.

3. A battery receptacle for use with a medical device as claimed in claim 1, wherein said at least one non-cylindrical battery is two batteries and said at least one cavity is two cavities each of which has a respective door, one of said two batteries is a primary battery and other is a reserve battery, and said two batteries in combination are adapted to provide an uninterrupted power supply to said medical device.

4. A battery receptacle for use with a medical device as claimed in claim 1, wherein said least one portion that allows said battery to be visible is disposed on said door.

5. A battery receptacle for use with a medical device as claimed in claim 1, wherein said door is made of a clear or translucent plastic.

6. A battery receptacle for use with a medical device as claimed in claim 5, wherein said door is made of polycarbonate.

7. A battery receptacle as claimed in claim 3, wherein said two doors are distinguished from each other by different colors and/or indicia marked thereon.

8. A battery receptacle as claimed in claim 1, wherein said door is lockable by use of a latch means.

9. A battery receptacle as claimed in claim 1, wherein said receptacle is for use with an implantable blood pump.
